(19) United States
(12) Patent Application Publication
(10) Pub. No.: US 2024/0373835 A1
(43) Pub. Date: Nov. 14, 2024

(54) THREE-DIMENSIONED BIRD REPELLER

(71) Applicant: KARADENIZ TEKNIK ÜNIVERSITESI, Trabzon (TR)

(72) Inventor: Alptug SARI, Trabzon (TR)

(21) Appl. No.: 18/250,283

(22) PCT Filed: Dec. 21, 2022
(86) PCT No.: PCT/TR2022/051557

§ 371 Date: Apr. 24, 2023

(30) Foreign Application Priority Data
Jul. 25, 2022 (TR) 2022/011766

(51) Int. Cl. A01M 29/06; A01M 29/16; A01M 29/26

(52) U.S. Cl. CPC A01M 29/06; A01M 29/16; A01M 29/26

(57) ABSTRACT

Disclosed is a bird repeller for preventing damages caused by dangerous animals, the bird repeller having a three dimensioned raptorial animal model, a cover, a solar panel, a battery, electric transmitted metals, a sound system, a camera, a motion sensor, a remote control system, a remote command, vacuum wheels, damper springs and a damper.

### TECHNICAL FIELD TO WHICH THE INVENTION RELATES

The Invention relates to bird repeller for wild animals, particularly birds, caused damage control and management primarily at airports.

The invention particularly relates to a bird repeller capable to move on any ground and patrol manually by video remote control as well as patrolling in the determined route to keep all bird species away without damaging them.

### PRIOR ART

The activities conducted in outdoor areas such as airports, agricultural areas, transport, production facilities, etc. may be subject to damage by external factors. All bird species such as raptorial birds, migratory birds mainly local bird species may cause damage while flying, nesting or temporarily staying. For that reason, today areas such as airports, agricultural areas, stores, car parks, fishing farms, and production plants have various methods or devices to keep birds away in order to avoid damages.

Up to the present time, multiple systems have been used at airports to fight against damages caused by wild animals but no solution has been achieved for the problem. The same case is also true for agricultural areas. Agricultural lands are tried to be protected by means of using bird scares of various views. The motionless structure of the bird scarer in use has made them inadequate as the birds get used to it over time.

Trained dogs or trained raptorial birds were also used to keep birds away. The use of trained dogs or raptorial birds only provides impact on small bird species while they are not effective to keep a fleet of birds or big bird species away. In addition, it is considerably difficult, expensive, and effort demanding work to find trained dogs together with trainers and keep them in the field all the time.

Another method employed for keeping birds away is the use of metallic wire or barbs. Having barbs on such wires or barbed wire or barbs given electric current only prevents birds from standing in such areas. They do not provide any deterrence for birds coming to such areas.

It is known that birds landing on electric wires or electrical accessories not only damage themselves but also damage the functioning of the sites. To prevent it, electro-shock to generate vibration in birds' bodies is applied by use of electric current. The electro-shock application may sometimes damage birds as the birds' species or body size is not taken into account and sometimes it may remain ineffective to keep birds away. Furthermore, in this application, not only birds but also any other living or unloving things may be subject to it.

In order to eliminate such negativities, bird repellers are developed by use of devices developed with scientific studies. The bird repellers are developed with data collectors such as sensors or cameras and devices moving to keep birds away and also giving sound warnings and applying electro-shock are produced. The devices detect moving objects by means of cameras and activate moving parts to scare birds. The devices can be of fixed structure as well as move on land or in the air.

Birds are tried to be kept away in airports, agricultural lands, or production plants by use of drones having raptorial bird models. As drones are remote-controlled, they can only be used in certain areas. In addition, they consume a high amount of energy while flying and their electronic accessories of them are influenced by adverse weather conditions.

Robots having wheels and noise warnings and electroshock applications to keep away birds are not effective because of land conditions, energy needs, and movement with remote control.

The prior art utility model numbered “TR201902413” and entitled “OVAL BIRD REPELLER BARRIER” is examined. The abstract of the application being subject of the application reads as “This invention relates to an oval bird repeller barrier that can be used over electric transmission lines on roof and window sides in architectural buildings and all surfaces where birds land in and characterized by comprising a plastic body made from resistant plastic material and a various number of plastic oval parts fixed in serials on the plastic body.”

The prior art patent file numbered “TR201412802” and entitled “Electro-mechanical system not allowing birds landing” is examined. The abstract of the invention being the subject of this application reads as “the invention is a complete repelling system preventing the landing of birds onto poles of high voltage transmission lines by means of visual, audio, mechanical and nerve means. The system of the invention comprises a main body where mechanical repellers are placed, shoes providing mounting of the device not allowing landing of birds (FIG. 2) onto electric poles, mechanical repellers having audio, visual and mechanical deterrence, parts giving high and low-frequency sound signs and low range magnetic signs to the main body and by the help of mechanical repellers and affecting nerve system of bird and thus providing loss of control abilities of them.”

The prior art utility model numbered “TR201300802” and entitled “ultrasonic bird repeller of two different body types” is examined. The abstract part of the invention subject of the invention reads as “Invention relates to ultrasonic bird repeller giving noise in a frequency range that can be heard by only birds and used for purpose of keeping birds away by scaring them in the lands where it is desired to keep wild birds away. The ultrasonic bird repeller of the invention can be used with two different body types.

The prior art utility model numbered “CN211910286U” is examined. The invention being the subject of the application discloses a stable performance solar split type smart high voltage shock bird disperser comprising a radar sensor, a single chip computer, sound module, high voltage generator, discharge plate containing a power circuit, and the main machine body.

The prior art utility model numbered “CN210869604U” is examined. The invention of the application discloses a smart bird-repelling robot comprising a noise bird repeller, a camera, a rotary mechanism, an antenna, a control box, a laser, an ultrasonic transmitter, a road definition module, and the wheel.

### PURPOSE OF THE INVENTION

The primary purpose of the invention is to provide a bird repeller capable to move under all land conditions with a damper wheel system. Thus, it is a bird repeller usable in all lands without impact by disorders on the land surface.

Another purpose of the invention is to enable adjustment of the damper wheel system by detecting holes and bulges on the route with help of the camera. Thus, the disorders on the land ground are detected in advance and the bird repeller is enabled to move without encountering any shock effect arising from land surface disorders.

Another purpose of the invention is to provide a bird repeller patrolling without allowing birds to get used to it by raptorial animal model and sound system. Thus, birds' getting used to bird repellers over time is prevented and it can have to repel and remove effects on birds all the time.

Another purpose of the invention is to provide needed energy with help of solar panels. Thus, charging or battery replacement for movement of bird repeller, sound warning, and electroshock applications are eliminated by means of a nature-friendly bird repeller by use of renewable energy source.

Another purpose of the invention is to enable patrolling on a specified route. Thus, while removing birds, route security and control of the surrounding is provided by the use of the camera.

Another purpose of the invention is to generate vibration in birds and thus disturb them and remove them from the area by applying electroshock to birds landing thereon with help of electric transmitting metals. With the use of electroshock, it is aimed to prevent the birds from getting used to the device.

Another purpose of the invention is to conduct control by remote control where required. Thus, bird repellers can be transferred to the places needing intervention outside the specified route.

Another purpose of the invention is to detect birds with help of the camera and motion sensor. Thus, no danger is caused for living beings not performing any damaging actions.

### DESCRIPTION OF FIGURES

FIG. 1 is a drawing giving view of bird repeller of the invention.

FIG. 2 is a drawing giving view giving relatively left side of bird repeller of the invention.

FIG. 3 is a drawing giving view giving relatively right side of bird repeller of the invention.

FIG. 4 is a drawing giving top view of bird repeller of the invention.

FIG. 5 is a drawing giving bottom view of bird repeller of the invention.

FIG. 6 is a drawing giving detailed view of bird repeller of the invention.

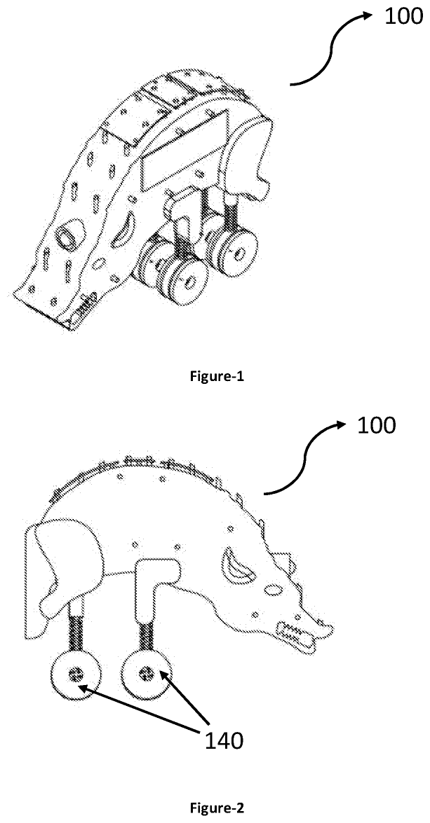

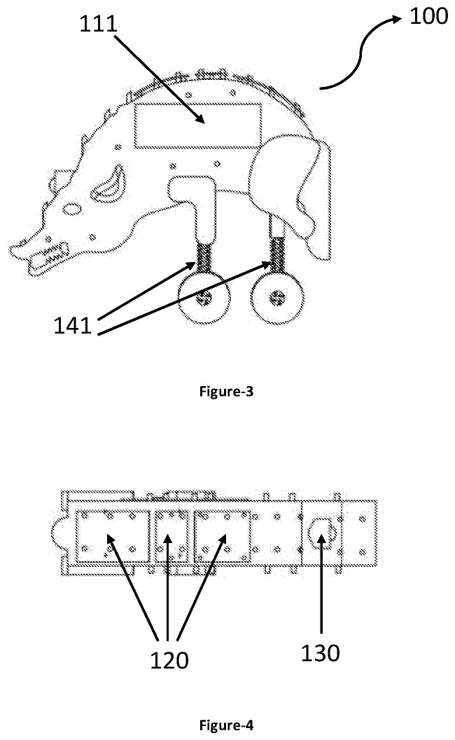

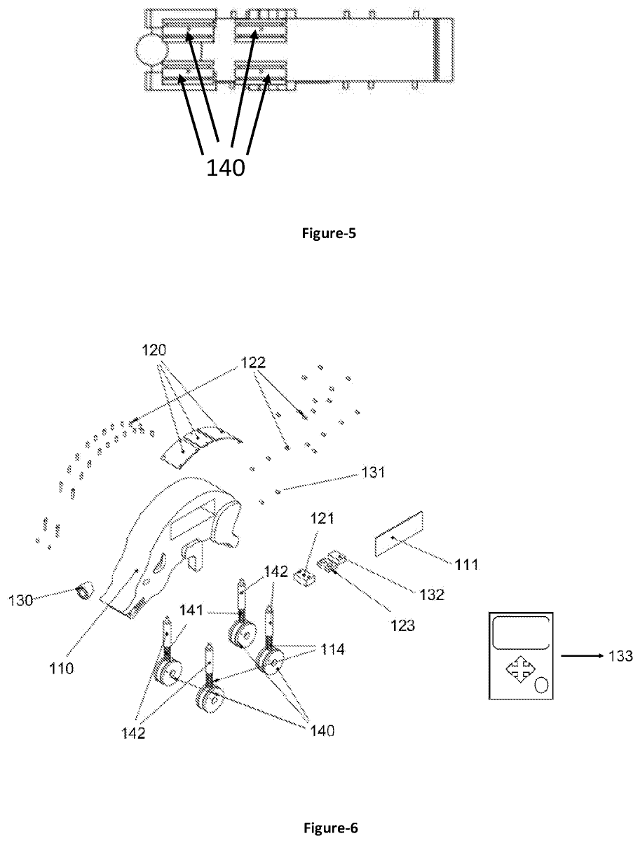

### REFERENCE NUMBERS

100. Bird Repeller
110. Model
111. Cover
120. Solar Panel
121. Battery
122. Electric Transmitter Metals
123. Sound System
130. Camera
131. Motion Sensor
132. Remote Command Control System
133. Remote Command
140. Vacuum Wheels
141. Damper Springs
142. Damper

### DESCRIPTION OF THE INVENTION

Invention is a three-dimensioned bird repeller (100) comprising three-dimensioned raptorial animal model (110), cover (111), solar panel (120), battery (121), electric transmitter metals (122), sound system (123), camera (130), motion sensor (131), remote control system (132), remote command (133), vacuum wheels (140), damper springs (141) and damper (142).

Three-dimensioned raptorial animal model (110) is designed real like to enhance deterrence feature of the system. Three-dimensioned raptorial animal model (110) is a model (110) of animals that birds are scared of and not approaching instinctually and so affects birds visually with its high convincing appearance. Cover (111) located on the model (110) provides access to control unit and internal accessories easily for maintenance, repair works.

Solar panels (120) are located on top surface of the three-dimensioned model (110) and provides energy needed for movement of bird repeller (100). The battery (121) is power supply for electric transmitter metals (122). Electric transmitter metals (122) are located on top surface and right and left side surfaces of the three-dimensioned model (110). Electric transmitter metals (122) give electroshock to damaging species placed onto the model (110). Electroshock application makes harmful species moving onto bird repeller (100) to accept bird repeller (100) as dangerous indistinctively. However, electroshock applied by electric transmitter metals (122) will not cause life danger for animals and be in 0.01-0.1 voltage range. Sound system (123) gives sound of raptorial animal model (110) upon motion sensors (131) become active. Thus, it enhances convincing feature of the model (110) and makes birds perceive the bird repeller (100) more realistic.

The camera (130) is placed on face part of the animal figure of the model and is used to display movements performed in front of the model (110). The camera (130) used to detect movement direction of the bird repeller (100) can provide image simultaneously for determining route in cases requiring use of remote control command system (132). The image provided by the camera (130) can be tracked on the screen on the remote command (133). Thus, when bird repeller (100) is patrolling, control of the surrounding can also be provided. Motion sensors (131) are placed on right and left sides of the three dimensioned model (110). Thus, in case of approaching to the bird repeller (100) from right and left, the motion is detected and movement of bird repeller (100) and activation of electric transmitter metals (122) and activation of sound system (123) after it are provided. Remote control command system (132) runs in wireless communication protocol and provides remote control of the bird repeller (100). The remote command (133) has a screen enabling user to watch the images from the camera (130) and direction keys to determine direction of the bird repeller (100) and a command button enabling operation of sound system (123) independent of motion sensors (131). Remote control command system (132) ad remote command (133) communicate through use of wireless communication protocol.

Vacuum wheels (140), damper springs (141) and damper (142) provides operation of the bid repeller (100) under all land conditions. Vacuum wheels (140) provides grasp of bird repeller (100) onto any grounds. It has damper springs (141) absorbing shocks arising from land surface irregularities encountered by bird repeller (100) subject to hills and holes that may be available on the land. Damper springs (141) run with dampers (142) balancing wheel vibrations caused by springs on bumpy roads and thus enables bird repeller (100) to move in any land conditions.

1. A bird repeller comprising;
a model having a three-dimensioned raptorial animal figure thereon, containing a cover enabling access to a remote control system and electronic internal accessories, located relatively on left side of the bird repeller, preventing impact of space providing access to internal accessories of the bird repeller in maintenance. repair, replacement or development, by weather conditions, and real like appearance scaring bird species,
a solar panel located on the model, providing energy needed by bird repeller movement, a sound system, a motion sensor, a camera and a remote command control system,
a battery generating voltage required for electroshock application of electric transmitter metals,
an electric transmitter metals locater on top part, right and left side surfaces of the model and conducting electroshock application,
a sound system giving sound of animal figure selected in raptorial animal model,
a camera used to determine movement direction of the bird repeller and watch the surrounding and located on face part of animal figure,
a sensor located on right and left side surfaces of the model and detecting movement on the right and left as per direction when the bird repeller moves and activating the bird repeller, the electric transmitter metals and the sound system,
a remote command control system providing remote control of the bird repeller and having wireless communication protocol,
a remote command providing running screen providing instant display of images coming from the camera, direction keys to determine movement direction of the bird repeller and the sound system independent of the motion sensor to enable remote control of the bird repeller and having wireless communication protocol,
vacuum wheels enabling the bird repeller grasp onto land surface to move under land conditions,
a damper having damper springs absorbing shock effects caused by surface irregularities encountered by the bird repeller under land conditions, balancing wheel vibration caused by springs on bumpy roads.

2. The bird repeller according to claim 1, wherein the remote command control system enables patrolling on a specified route.

3. The bird repeller according to claim 1, wherein the electric transmitter metals provide application of electroshock in 0.01-1 voltage range.

4. The bird repeller according to claim 1, wherein the three dimensioned model reflects a visual of any raptorial animals' figures.

5. The bird repeller according to claim 1, wherein the sound system provides a sound of animal as per the three dimensioned model.
